(19) United States
(12) Patent Application Publication
(10) Pub. No.: US 2026/0278749 A1
(43) Pub. Date: Sep. 17, 2026

(54) SYSTEM AND METHOD FOR RENDERING VIDEO STREAM OUTPUTS

(71) Applicant: Sony Interactive Entertainment Europe Limited, London (GB)

(72) Inventors: Andrew William Walker, London (GB); Jun Yen Leung, London (GB); Neil Jonathan Brown, London (GB); Hagen-Christian Tonnies, London (GB); Mark Anderson, London (GB)

(21) Appl. No.: 19/562,287

(22) Filed: Mar. 10, 2026

(30) Foreign Application Priority Data
Mar. 11, 2025 (GB) 2503557.7

(51) Int. Cl. G06T 5/70; G06T 5/50; G06V 20/70

(52) U.S. Cl. CPC G06T 5/70; G06T 5/50; G06V 20/70; G06T 2207/20221

(57) ABSTRACT

There is described a computer-implemented method for rendering video stream outputs, the method comprising; generating a rendering pipeline comprising a plurality of rendering tasks; determining a first rendering task of the plurality of rendering tasks to be rendered differently dependent on one or more characteristics of a user; and producing a first video stream output to be displayed to a first user having a first characteristic; and amending the first rendering task based on a characteristic of a second user, wherein the characteristic of the second user is different to that of the first user, and producing a second video stream output to be displayed to the second user. There is also described a computer program product and a system.

### CROSS-REFERENCE TO RELATED APPLICATIONS

This application claims priority to United Kingdom Application No. 2503557.7, filed on Mar. 11, 2025, the contents of which are incorporated herein by reference.

### FIELD

The present invention relates to a computer-implemented method for rendering video stream outputs. The present invention also relates to a computer program product and a system.

### BACKGROUND

The content of a video stream output, such as a video game, is often tailored to a particular audience or group of video game users. Therefore, the content of the video game can sometimes be unsuitable or inappropriate for wider or different audiences.

It may be too computationally expensive, unfeasible or impossible for a video stream output to be tailored to each type of audience which may interact with or spectate the video stream output. As such, video stream output users may be accessing inappropriate content unintentionally, for example by viewing the video game stream of another video game user.

Additionally, it is desirable for video stream output users to maintain privacy when streaming their video stream output to an audience. It may be unsafe or undesirable for personal information regarding the video stream output user to be displayed to the audience.

Objects and aspects of the present claimed invention seek to alleviate at least these problems with the prior art.

### SUMMARY

According to a first aspect of the invention, there is provided a computer-implemented method for rendering video stream outputs, the method comprising; generating a rendering pipeline comprising a plurality of rendering tasks; determining a first rendering task of the plurality of rendering tasks to be rendered differently dependent on one or more characteristics of a user; and producing a first video stream output to be displayed to a first user having a first characteristic; and amending the first rendering task based on a characteristic of a second user, wherein the characteristic of the second user is different to that of the first user, and producing a second video stream output to be displayed to the second user. Wherein producing a video stream output comprises rendering the plurality of rendering tasks.

The video stream outputs may be, for example, a video game or a virtual event. Embodiments of the invention will be described herein in relation to the video stream output comprising a video game, although it is understood that these examples are non-limiting and alternative video stream outputs may be used in the embodiments and examples provided below.

The first aspect provides an improved method of video game rendering, as the rendering pipeline can be altered to produce a modified video stream output which is more appropriate for or suited to the user of the video game. The video stream output is understood to be the video, and optionally audio, stream produced by rendering the rendering pipeline. By rendering at least one rendering task in a modified manner in response to a characteristic of the video game user, the video stream output of the rendering pipeline is better suited to the user's characteristics and requirements.

Additionally, user privacy can be controlled, as sensitive or private information about the user can be modified or omitted during rendering. In this way, the safety of the user is improved, along with the user's experience.

Rendering differently and amending the first rendering task may comprise one or more actions to modify, adapt or otherwise change the rendering pipeline to produce a modified output compared to the original, unmodified rendering pipeline for the first user. The term ‘different’ is understood to be different relative to the original, unmodified output. Namely, by amending the first rendering task, the output of the rendering pipeline is adapted to the one or more characteristics of a user of the video game.

According to a second aspect of the present invention, there is provided a computer program product including one or more executable instructions which, when executed by a computer, causes the computer to carry out the method of the first aspect of the invention.

According to a third aspect of the present invention, there is provided a system comprising; a processor configured to implement the method of the first aspect of the invention; a memory; and at least one display device.

### BRIEF DESCRIPTION OF THE DRAWINGS

Embodiments of the present invention will now be described by way of example only and with reference to the accompanying drawings, in which:

FIG. 1 depicts a flow diagram of a method according to an embodiment of the first aspect of the present invention;

FIG. 2 depicts a flow diagram of a second embodiment of a method according to the first aspect of the present invention;

FIGS. 3a to 3e depict video stream outputs produced from the method of FIG. 2;

FIG. 4 depicts a flow diagram of a third embodiment of a method according to the first aspect of the present invention;

FIGS. 5a and 5b depict video stream outputs produced from the method of FIG. 4;

FIGS. 6a and 6b depict video stream outputs produced from the method of FIG. 4;

FIG. 7 depicts a flow diagram of a fourth embodiment of a method according to the first aspect of the present invention;

FIGS. 8a and 8b depict video stream outputs produced from the method of FIG. 7; and

FIGS. 9a and 9b depict video stream outputs produced from the method of FIG. 7.

FIG. 10 illustrates a block diagram of one example implementation of a computing device that can be used for implementing the method described throughout the detailed description.

### DETAILED DESCRIPTION

The following detailed description is merely illustrative in nature and is not intended to limit the embodiments of the subject matter or the application and uses of such embodiments. As used herein, the words “exemplary” and “example” mean “serving as an example, instance, or illustration.” Any implementation described herein as exemplary or an example is not necessarily to be construed as preferred or advantageous over other implementations. Furthermore, there is no intention to be bound by any expressed or implied theory presented in the preceding technical field, background, or the following detailed description.

The present disclosure provides a method for determining content of a video game to be modified in relation to a characteristic of the user, and for removing or altering content which is private, sensitive or otherwise inappropriate. The content of the video game altered or adapted is dependent on the specific user characteristic. In particular, the method of the present invention may address some of the disadvantages and frustrations that users with accessibility, language, age or other requirements when viewing or playing a video game. Generating alternative rendering pipelines allows video game content to be made appropriate for the age, language and other characteristics of the user.

The first user and/or second user of the video stream output may be, for example, a player of the video game or a spectator of the video game, in particular a spectator of a video stream of a video game. As such, the user of the video game is not required to be an active participant playing the video game, and may instead be a passive spectator. Streaming a video game is understood to be when media content relating to the video game, in particular gameplay content, is delivered to a third party device for the third party to spectate or observe, either in real time or after the fact.

In some embodiments, amending the first rendering task comprises, for the second user, bypassing the first rendering task to produce the second video stream output. In this way, the content of the first rendering task is not rendered, thereby omitting the content from the second video stream output. As such, the modification is the omittance of the content of the first rendering task. For example, the first rendering task may comprise rendering a visual object such as graffiti shown in the environment of the video game or a logo on a character's outfit, which is omitted from the second video stream output.

In this example, inappropriate or explicit visual objects can be removed from the produced video stream output. Such a solution improves resource allocation as the content of the first rendering task is not unnecessary prior to producing the second video stream output, such that computational resource can be used elsewhere.

It is understood that the content of the first rendering task may be one or more of: a colour; a hue; a visual object; text; a sound; or music.

In some embodiments, amending the first rendering task comprises, for the second user, modifying a content of the first rendering task to produce the second video stream output. In this way, the content of the first rendering task is adapted to the characteristic of the second user prior to rendering.

Optionally, modifying comprises removing at least a portion of the content of the first rendering task. For example, the content may comprise a character outfit and the modification may be the removal of a weapon from the character outfit. Optionally, modifying comprises removing the entire content. For example, the content may comprise blood and/or gore displayed after injury or death of a character in the video game and modifying may comprise removing the blood and/or gore. Optionally, modifying comprises replacing the content. For example, the content may comprise a first song having English lyrics and modifying may comprise replacing the first song with a second song having Spanish lyrics.

In some embodiments, a rendered content of the first rendering task to be modified comprises text associated with the first user. For example, the text may comprise one or more of: a name; a username; and/or a geographic location. The username, handle or other identification name associated with the first user may comprise private information such as the user's first and/or last name. The first user may not wish to display their name in the second video stream output, in particular, in instances where the second video stream output may be made available to second user's unknown to the first user, such as during streaming of a video game.

In some embodiments, modifying the content for display to the second user comprises replacing the text associated with the first user with a visual object or different text. For example, the text associated with the first user may be a username displayed underneath a health bar associated with the first user's character. Modifying the content may comprise replacing the username with a coloured strip. In this example, the first user's characterer may be wearing a green outfit and the coloured strip may be a green strip. In this way, the first rendering task is modified such that the first user's character can be identified in the video game without displaying the first user's username, thereby improving privacy. Alternatively, there may be no need to identify the first user's character and the visual object may comprise an aesthetic graphic such as, for example, a vine or cloud if the video game is set in a forest. As such, the username is covered or otherwise obscured by the aesthetic graphic.

Optionally, modifying the content for display to the second user comprises blurring the text associated with the first user with a visual object. In this way, the username or other sensitive text can be obscured from view without impacting the overall appearance of the second video stream output.

In some embodiments, the content of the first rendering task to be modified for display to the second user comprises a visual object, wherein modifying the content comprises blurring the visual object. In some embodiments, the content of the first rendering task to be modified for display to the second user comprises a visual object, wherein modifying the content comprises overlaying the visual object with a predetermined modified visual object. In some embodiments, the content of the first rendering task to be modified for display to the second user comprises a visual object, wherein modifying the content comprises blurring the visual object and/or overlaying the visual object with a predetermined modified visual object.

For example, the content of the visual object may comprise a NPC (non-playable character). The NPC may be a monster, zombie, gangster or other character suitable for the age rating of the video game. Such characters may be inappropriate for a viewer under the age rating of the video game, such as a second user under the age of eighteen for an ‘18’ rated video game. The NPC may be blurred, such as to obscure the depiction of blood or gore, and/or the NPC may be overlaid with a predetermined alternative NPC, such as overlaying an Easter Bunny NPC on a zombie NPC. In this way, the video stream output is at least partially modified to be appropriate for an audience younger than the video game rating.

In some embodiments, the method further comprises: pausing rendering of the rendering pipeline when the first rendering task to be rendered differently is determined. In this way, computational resource is not wasted in rendering the first rendering task in an unmodified manner before the content of the first rendering task is rendered differently. Optionally, the method further comprises: resuming rendering of the rendering pipeline after the first rendering task to be rendered differently is determined; and rendering the first rendering task of the plurality of rendering tasks differently.

In some embodiments, the method further comprises tagging the first rendering task. In this way, the first rendering task of the plurality of rendering tasks to be rendered differently can be easily identified during subsequent iterations of rendering the rendering pipeline.

In some embodiments, the method further comprises: generating a first rendering pipeline comprising a first version of the tagged rendering task; and generating a second rendering pipeline comprising a second version of the tagged rendering task. In this way, during subsequent iterations of the rendering pipeline, whether the first rendering pipeline or second rendering pipeline is selected to be rendered can be based on whether the user possess the first user characteristic or second user characteristic.

In some embodiments, the first version of the tagged rendering task is an unmodified version of the first rendering task. In this way, an original, unmodified video stream output can be produced when the first rendering pipeline is rendered.

In some embodiments, the method wherein the first video stream output is associated with the first rendering pipeline and the second video stream output is associated with the second rendering pipeline. In this way, the first rendering pipeline and second rendering pipeline are configured to render the first video stream output and second video stream output, respectively.

For example, the first and second devices may comprise a console comprising a screen, a computer, a television, a monitor or a portable electronic device such as a phone or tablet. In this way, the video stream output can be displayed on at least two devices, with different video stream content shown on the at least two devices. For example, the first video stream output may comprise the rendered unmodified version of the first rendering task and may be displayed to the first user who is the player of the video game and falls within the age rating category of the video game. The second video stream may comprise a censored or otherwise modified version of the video game content and can be displayed to, for example, the second user who falls under the age rating of the video game.

Optionally, the method further comprises amending the first rendering task based on a characteristic of a third user, wherein the characteristic of the third user is different to the characteristic of the first user and/or second user and producing a third video stream output to be displayed to the third user. Optionally, the characteristic of the third user is different to the characteristic of the first user and the second user. Optionally, the method comprises generating a third rendering pipeline comprising the third version of the tagged rendering task; and displaying the third video stream output on a third device associated with the third user of a video stream output, wherein the third video stream output is associated with the third rendering pipeline.

For example, the first user may be the player of the video game and the second user may be a stranger who does not know the first user but who is streaming the content of the video game being played by the first user. The third user may be a friend of the first user who is also streaming the content of the video game being played by the first user. The tagged rendering task may comprise the username of the first user displayed during gameplay. The first version of the rendering task may be identical to the third version of the rendering task as the third user is a friend of the first user and so it is not necessary to hide the username of the third user. The second rendering task may comprise blurring the username, such that the second user is not shown the username, thereby improving privacy and safety of the first user.

Optionally, the method comprises generating a plurality of rendering pipelines, each rendering pipeline associated with a version of the tagged rendering task; and displaying a plurality of modified video stream outputs on a plurality of devices associated with a plurality of users of the video game, wherein each of the plurality of modified video stream outputs is associated with a rendering pipeline of the plurality of rendering pipelines. Optionally, each characteristic of the plurality of characteristics is different from each other characteristic of the plurality of characteristics.

In some embodiments, displaying the first video stream output on the first device and displaying the second video stream output on the second device occurs simultaneously. Wherein the first user is live streaming video game content, it is advantageous to stream the video game content to the second user at substantially the same time as the first user is playing the video game.

In some embodiments, generating the second video stream output comprises: modifying the first video stream output by replacing a first version of the tagged rendering task rendered in the first rendering pipeline with the rendered second version of the tagged rendering task rendered in the second rendering pipeline. In this way, greater rendering efficiency can be achieved, as minimum computational resource is required to generate, render and/or store the second rendering pipeline.

In some embodiments, the one or more characteristics of the first user and/or second user comprises one or more of the following: name; username; geographic location; language; age; relationship to the first user; and/or accessibility requirement. In some embodiments, the characteristic of the first user may be a lack of characteristic of the second user or the characteristic of the second user may be a lack of characteristic of the first user.

For example, the characteristic may be whether the second user is a ‘friend’ or otherwise ‘approved’ by the first user. In this way, adapting the second version of the tagged rendering task to a characteristic of the first user can be determined on whether the second user possess a security clearance from the first user to view, for example, their real name or location. In another example, the characteristic may be whether the user is colour-blind. If the first user is colour-blind and the second user is not colour-blind, the first video stream output can be rendered to show content with a colour overlay meeting the accessibility requirements of the first user, and the second video stream output can comprise the rendered unmodified version of the first rendering task. In another example, the first user may possess a hearing impairment which the second user does not. Rendering tasks can therefore be modified to include additionally content, such as a closed caption overlay, to improve accessibility for the first user.

In some embodiments, determining the first rendering task of the plurality of rendering tasks to be rendered differently is determined by machine learning. Optionally, the method comprises inputting the user characteristic to a machine learning model; and identifying the first rendering task of the plurality of rendering tasks to be rendered differently using the machine learning model. Optionally, the method further comprises inputting the user characteristic to a machine learning model; calculating whether the first rendering task should be bypassed or modified in response to the user characteristic using the machine learning model.

Optionally, the method comprises inputting the language of the user into a machine learning model; determining which rendering tasks of the plurality of rendering tasks comprises text; and modifying the text of the determined rendering tasks to the language of the user. Optionally, the method comprises inputting the relationship to the second to the first user to a machine learning model; determining the security clearance of the second user; determining which rendering tasks of the plurality of rendering tasks comprise content unsuitable for the security clearance of the second user. Optionally, further comprising rendering the determined rendering task/s of the plurality of rendering tasks differently.

Optionally, the method further comprises determining a second rendering task of the plurality of rendering tasks to be rendered differently. Optionally, the method further comprises rendering the first rendering task of the plurality of rendering tasks to be rendered differently in a first manner and rendering the second rendering task of the plurality of rendering tasks to be rendered differently in a second manner. For example, the first manner may comprise bypassing the first rendering task to produce a modified video stream output and the second manner may comprise modifying the second rendering task to produce a modified video stream output. Optionally, the first manner and second manner are identical. It is understood that the term ‘manner’ refers to the way in which the content of the first rendering task is adapted, independent of the content of the first rendering task.

Optionally, the method further comprises determining at least one second rendering task of the plurality of rendering tasks to be rendered differently dependent on the first user characteristic and/or the second user characteristic. In this way, multiple elements of the content of the video game can be adapted to the user characteristics. For example, the second user characteristic may be the language of the second user, such as Japanese. The first rendering task may comprise the music played in the background of the game and the second rendering task may comprise the speech bubble of a character in the video game. In this case, rendering differently comprises modifying the music of the first rendering task to be the version with Japanese lyrics and modifying the text in the speech bubble to be Japanese to produce the second video stream output comprising both modified first and second rendering tasks.

It is envisaged the content of the first rendering task and, optionally, the at least one second rendering task comprises one or more of; a two-dimensional visual object, a three-dimensional visual object, a texture, lighting, background, text, colour, music, and/or audio. Wherein the rendering pipeline comprises music, sounds or other audio, the term render is also appreciated to include streaming or otherwise conveying the audio to the user device. In this way, the render pipeline may comprise audio as well as visual content to be rendered.

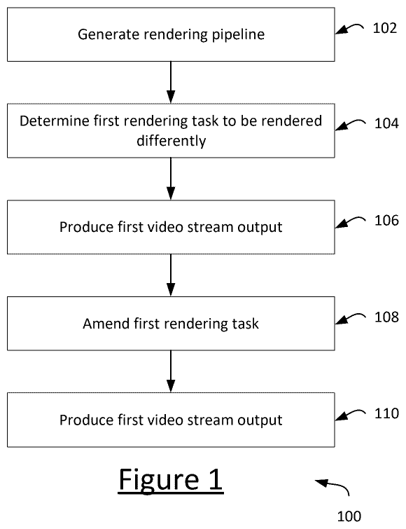

With reference to FIG. 1, a flow diagram of a method 100 according to the first aspect is provided.

In step 102, a rendering pipeline comprising a plurality of rendering tasks is generated. For example, the plurality of rendering tasks may each comprise content that makes up the elements of the video game, such as the background, the lighting, the playable character, the background music and a plurality of three-dimensional visual objects in the video game environment during gameplay. Each of the rendering tasks make up the video game content displayed to the user such that, once the rendering pipeline is rendered, the video stream output produced comprises the video content.

In step 104, a first rendering task of the plurality of rendering tasks to be rendered differently is determined dependent on one or more characteristics of the user. The one or more characteristics are the traits, features and/or preferences of the user, in particular the traits of the user which may impact or impede the user's experience playing with or viewing a video game. In a first example, the user characteristics may be the age of the user and the language of the user. Alternatively, in a second example, the user characteristic may be only that the user possesses a hearing impediment. A user may possess more than one relevant characteristic, and so it may be advantageous that the video stream output can be tailored to more than one of the user's characteristics.

With reference to step 106, a first video stream output is produced to be displayed to a first user having a first characteristic. Producing the first video stream comprises rendering the plurality of rendering tasks in the rendering pipeline, including the first rendering task. In one example, the first rendering task may be unamended from the originally generated rendering pipeline in step 102. In this way, video stream content appropriate for the first user can be displayed to first user.

With reference to step 108, the first rendering task is amended based on a characteristic of a second user, wherein the characteristic of the second user is different to that of the first user. For example, the characteristic of the first user may be that they are a Spanish speaker and the characteristic of the second user may be that they are an English speaker. Alternatively, the characteristic of the first user may be that they are a Spanish speaker and the characteristic of the second user may be that they are an age under that of the video stream output rating.

With reference to step 110, a second video stream output is produced to be displayed to the second user. Producing the second video stream output comprises rendering the plurality of rendering tasks including the first rendering task as amended. In this way, video stream content appropriate for the second user can be displayed to the second user.

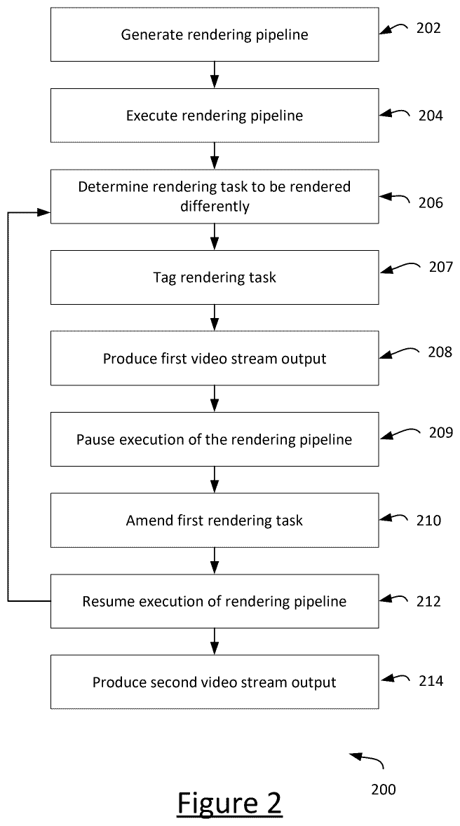

With reference to FIG. 2, a second embodiment of a method 200 according to the first aspect is provided.

In step 202, a rendering pipeline comprising a plurality of rendering tasks is generated. Typically, the rendering tasks are ordered by their importance or another relevant factor, such that rendering the rendering pipeline comprises rendering each rendering task in turn. For example, the importance of the rendering tasks may be defined by the priority of the rendering task, namely how early during gameplay it is required, or by the computational resource required to render the rendering task, namely whether the most or least computationally expensive rendering tasks are rendered first. In some embodiments, in step 204, the rendering pipeline is executed, such that each rendering task is rendered in turn.

In step 206, a first rendering task to be rendered differently is determined during the execution of the rendering pipeline. In one example, the content of the rendering task comprises text associated with a user such as the user's username. In this example, the text is associated with a characteristic of the user, namely the user's username. As this is personal information, the user is happy to be able to see their own personal information but does not want other people to be able to see this. Rendering of the username text is identified as a rendering task to be rendered differently for different users of viewers of the video game in this example.

In step 207 the first rendering task is tagged to improve ease of determining the content relevant to the user characteristic in subsequent iterations of the method 200.

In step 208, the first video stream output is produced to be displayed to the first user. In this embodiment, no modification is required to the render pipeline to adapt the video stream output to the characteristic of the first user.

In step 209, execution of the rendering pipeline is paused when the first rendering task to be rendered differently is determined. In this way, the first rendering task can be modified to adapt the first rendering task to the characteristic of the second user.

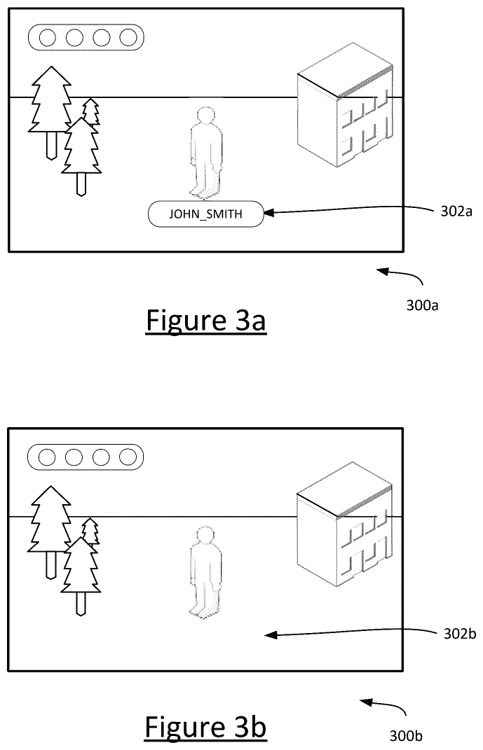

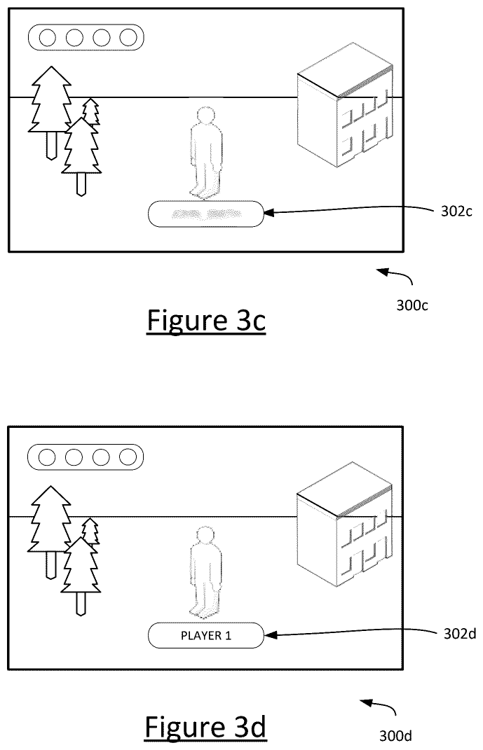

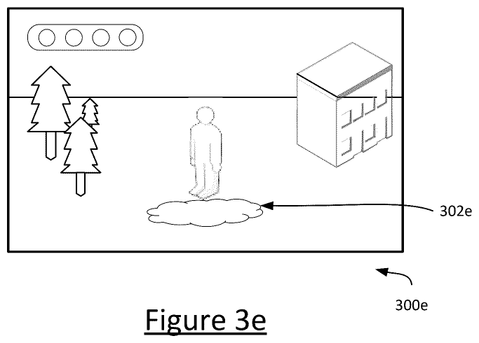

In step 210, the first rendering task is amended, such as by being modified or bypassed. The manner in which the first rendering task is adapted to match the characteristic of the second user can be determined based on the content of the first rendering task and the characteristic of the second user. Examples of how the first rendering task may be modified or bypassed are illustrated in FIGS. 3a to 3d. In step 212, execution of the rendering pipeline is resumed, wherein the first rendering task is rendered differently in response to step 210.

In step 214, a second video stream output is produced to be displayed to the second user. The second video stream is therefore adapted to the characteristic of the first user. In some embodiments, execution of the rendering pipeline in step 204 occurs after any one of steps 206 to 214. In some embodiments, in step 212 execution of the rendering pipeline comprises initiation of rendering of the rendering pipeline.

FIG. 3a illustrates an unmodified video stream output 300a comprising a username 302 displayed beneath the first user's character. In this example, the username is JOHN_SMITH. The username comprises sensitive information, in this example the full name reveals the identity of the first user which may allow the second user to determine other private information about the player. In this example, the party playing the video game is a first user, also described as “the player” and the party streaming the content of the video game played by the player is a second user. In other embodiments, the ‘player’ may be the first user and the ‘user’ may be the second user.

The characteristic of the second user may be their relationship to the first user. Namely, whether the second user is a ‘friend’ of the first user. For example, the first user may identify a list of predetermined second users who are authorised to view their username, namely friends of the first user whom the first user is comfortable identifying themselves to. The characteristic of the first user is that they are, inherently, on the lust of predetermined users authorised to view the username.

In a first instance, the second user is a friend of the first user and so is authorised to view their username. In this instance, execution of the rendering pipeline in step 204 is uninterrupted as there are no rendering tasks determined to be rendered differently. Alternatively, the first rendering task is determined as containing content relevant to the characteristic of the username. It may consequently be determined that the second user is a ‘friend’ of the first user and so step 210 is omitted and execution of the rendering pipeline is resumed in step 212. The unmodified video stream output 300a is displayed to the first and second users with the unmodified username 302a displayed.

Alternatively, the second user may have no relationship to the first user and is therefore not on the list of ‘friends’ identified by the first user. The second user may be given, for example, the status of ‘stranger’. As such, it is desirable that the first user's username is not displayed to the second user.

Step 206 determines that the content of the first rendering task comprises the username. The first rendering task is determined to be rendered differently to improve privacy of the first user in response to the second user's status of ‘stranger’. Rendering differently may be achieved in a number of ways. For example, step 210 may comprise bypassing the first rendering task. In this way, the first user's username is not rendered in the rendering pipeline used to render the image for the second user so that it is hidden from the second user. FIG. 3b illustrates a modified video stream output 300b comprising no username 302b, namely the username is not rendered and so is absent from the video stream output 300b.

Alternatively, step 210 may comprise modifying the first rendering task. Modifying the first rendering task may comprise blurring the text of the username. FIG. 3c illustrates a second modified video stream output 300c comprising a blurred username 302c. In this way, the second user cannot determine the username of the first user from the video stream output 300c.

Alternatively, modifying the first rendering task may comprise replacing the text of the username with alternative text. FIG. 3d illustrates a third modified video stream output 300d comprising an alternative username 302d. The alternative username may be any username, such as one selected from a list of predetermined usernames, which anonymises the first user. In this example, the alternative username is ‘PLAYER 1’. In this way, the second user cannot determine the identity of the first user from the video stream output 300d.

Alternatively, modifying the first rendering task may comprise replacing the text of the username with a visual object. FIG. 3e illustrates a fourth modified video stream output 300e wherein the username is replaced with an image of a cloud 302e. In this way, the second user cannot determine the real username of the first user from the video stream output 300e and the aesthetic appearance of the video stream output 300e is not impacted.

In step 201, determination of which modified video output 300b, 300c, 300d, 300e should be displayed to the second user may occur, such as using predetermined preferences set by the first user, second user and/or video game provider.

Further iterations of steps 206 to 214 may be performed such that at least one second rendering task to be rendered differently is determined in step 206. In this way, all rendering tasks relevant to the one or more characteristics of the user are identified, adapted and rendered to produce a first video stream output comprising video game content. Examples of rendering the rendering task differently in step 210 are illustrated below.

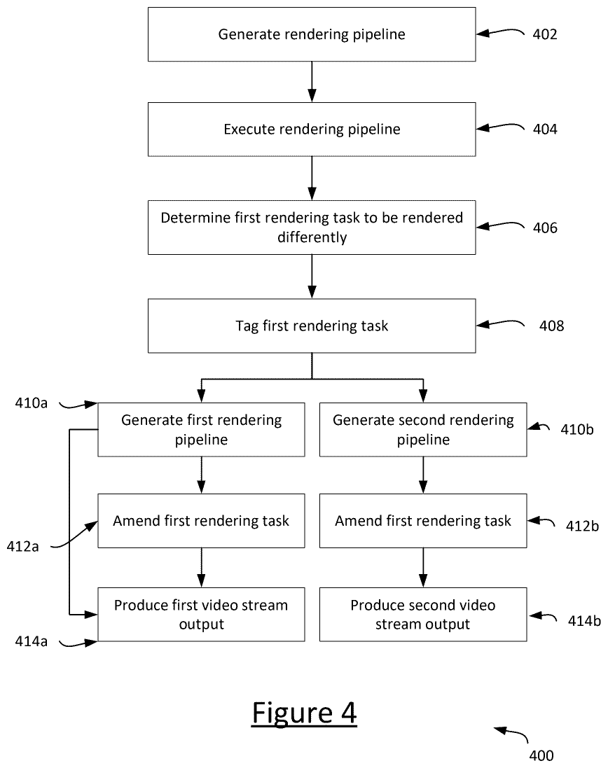

With reference to FIG. 4, a third method 400 according to the first aspect of the invention is depicted. In this embodiment, the user characteristic may be, for example, an accessibility requirement such as whether or not the user is colour-blind.

In a similar manner to the methods 100, 200 of FIGS. 1 and 2, step 402 comprises generating a rendering pipeline and step 404 comprises executing the rendering pipeline. Step 404 comprises determining a first rendering task of the plurality of rendering tasks to be rendered differently dependent on whether the user possess the characteristic, in this example, whether the user is colour-blind. For example, the content of the first rendering task may comprise rendering the colour of a plurality of visual objects within the video game. In step 408 the first rendering task is tagged to improve ease of determining the content relevant to the user characteristic in subsequent iterations of the method 400.

In step 410a, a first rendering pipeline is generated comprising a first version of the tagged rendering task of step 408. Optionally, in step 412a, the first version of the tagged rendering task is adapted to the characteristic of the first user. Step 412a is optional because, in some embodiments, the first version of the tagged rendering task comprises the original, unmodified content of the first rendering task and the content is not required to be rendered differently due to the characteristic of the first user.

For example, a first user may be the player of the video game and possess the characteristic of being not colour-blind, whereas the second user may possess the characteristic of being colour-blind. In step 414a, a first modified video stream output is produced to be displayed on a first device associated with the first user, wherein the first modified video stream output is associated with the first rendering pipeline of step 410a. In this example, step 412a is bypassed and the first video stream output is the unmodified video stream output. The first user does not possess the second user characteristic and so there is no need to modify the colour of a plurality of visual objects within the video game.

Similarly, in step 410b a second rendering pipeline is generated comprising a second version of the tagged rendering task. In step 412b, the second version of the tagged rendering task is bypassed or modified. For example, the colour of the plurality of visual objects can be modified to a colour-blind accessible colour. In step 414b, a second video stream output is produced to be displayed on a second device associated with the second user, wherein the second video stream output is associated with the second rendering pipeline of step 410b. In this example, the second user possesses the user characteristic of being colour-blind and so it is advantageous to modify the colours within the video game. The video stream outputs for the first user and second user are therefore tailored to fit their accessibility requirements.

Steps 412a and 412b may occur simultaneously, which is advantageous when the first user and second user are playing and/or viewing the video game content in real time.

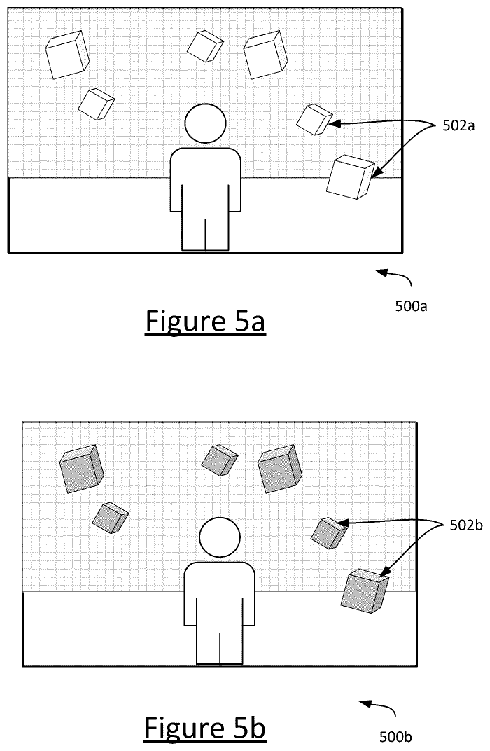

An example of the first modified video stream output 500a displayed in step 414a is depicted in FIG. 5a. Herein, the plurality of visual objects 502a within the video game are coloured their original, unmodified colour. Additionally, an example of the second modified video stream output 500b displayed in step 414b is depicted in FIG. 5b. Herein, the colour of the plurality of visual objects 502b is modified to a second colour, the second colour being easier to detect relative to the background and other colours within the video game, thereby improving accessibility of the video game for the second user.

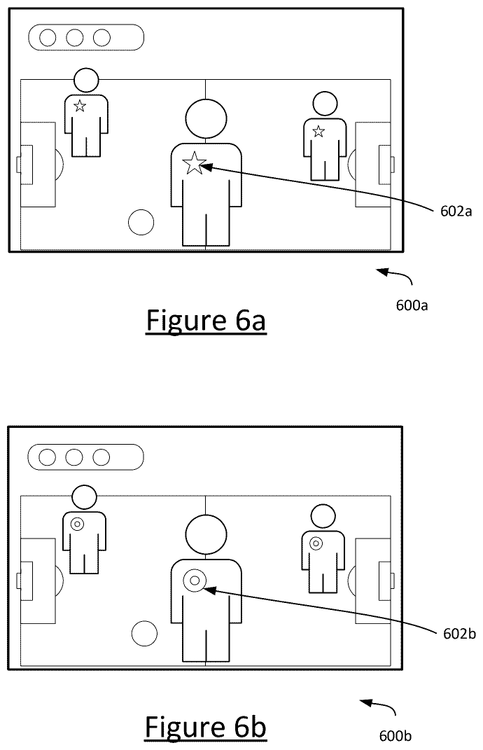

In another embodiment, the content of the first rendering task identified in step 406 may include rendering an image of a logo on a kit for a national sports team. The characteristic of the user may be, for example, the user's favourite national sports team. The first and second versions of the tagged rendering task may be adapted based on the favourite national sports team of the first user and second user, respectively (assuming that the first user and second user have different preferences) to show a logo for a different national sports team to each user. For example, the first video stream output 600a depicted in FIG. 6a may be displayed in step 414a of the above method 400, and the second video stream output 600b depicted in FIG. 6b may be displayed in step 414b. The content of the first tagged rendering task is modified to comprise a first logo 602a of a first national team and the content of the second tagged rendering task is modified to comprise a second logo 602b of a second national team. In the illustrated example, the first logo 602a is a star logo corresponding to the logo of the preferred national sports team of the first user, for example the German football team, and the second logo 602b is a circular logo corresponding to the logo of the preferred national sports team of the second user, for example the French football team.

In a similar manner, embodiments of methods 200, 400 of the invention may be used to update outdated logos, colours, patterns or other features of sports kit or other clothing, outfits or attire of characters in the video game. Similarly, banners, flags, buildings, backgrounds and other features that show outdated branding and logos can be updated by rendering the rendering tasks comprising this content differently. In this way, the content of the video game can be kept up to date without generating an entirely new rendering pipeline. It will be understood that the above-described example is for illustrative purposes only and is not intended to be limiting.

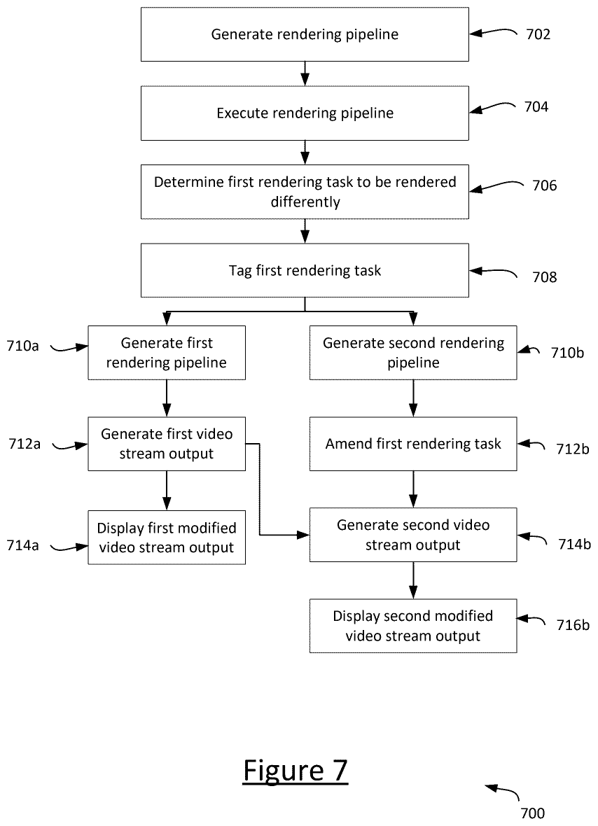

FIG. 7 illustrates a fourth embodiment of a method 700 in accordance with the first aspect of the invention. Steps 702 to 708, 710a, 710b and 712b are substantially identical, respectively, to steps 402 to 408, 410a, 410b and 412b of the method 400 of FIG. 4. Following the generation of the first video stream output of step 710a, a first video stream output is generated comprising a first version of the tagged rendering task, in step 712a, the first video stream output comprising the rendered first version of the tagged rendering task is then displayed on a first device associated with a first user of the video game in step 714a.

Following generation of the second rendering pipeline in step 710b, step 712b comprises amending, such as bypassing or modifying, the tagged rendering task to produce a second version of the tagged rendering task. In step 714b, generating the second video stream output may comprise modifying the first video stream output by replacing the first version of the tagged rendering task rendered in the first rendering pipeline with the rendered second version of the tagged rendering task rendered in the second rendering pipeline. The second video stream output can then be displayed on a second device associated with a second user of the video game in step 716b.

In this way, the other rendering tasks of the first rendering pipeline which are not related to the user characteristic are generated only once over both the first and second rendering pipelines. Only the one or more tagged rendering tasks associated with the user characteristic are rendered differently in relation to the first and second rendering pipelines, with the second rendering pipeline benefiting from the prior generation of the first video stream output in step 712a. Computational resource efficiency is therefore improved, as the non-tagged rendering tasks are only generated once.

For example, the user characteristic may be user's language. The content of the determined first rendering task to be rendered differently in step 706 may comprise text displayed in gameplay environment, such as graffiti on a building within the gameplay environment. Despite selecting the desired language of the video game before or during gameplay, ambient text in the environment of the video game may not be altered to match the selected language of the game. It may be computationally inefficient to produce multiple rendering pipelines comprising the ambient text in each possible selected language of the game. In this way, it is advantageous to determine the rendering task/s comprising ambient text and rendering these tasks differently in response to a characteristic of the user, such as language.

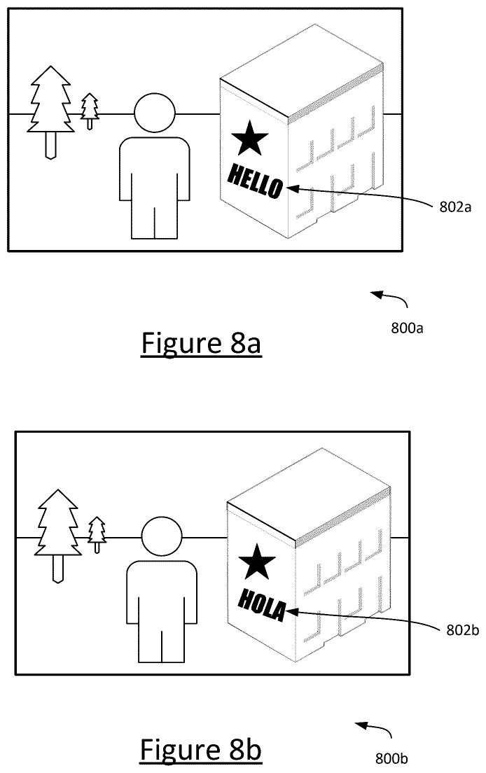

FIG. 8a illustrates a first modified video stream output 800a which may be produced from the method 700 of FIG. 7, the first modified video stream output 800a comprising English graffiti text 802a which may be displayed for a user with their language settings set to English. FIG. 8b illustrates a second modified video stream output 800b comprising Spanish graffiti text 802b which may be displayed for a user with their language settings set to Spanish.

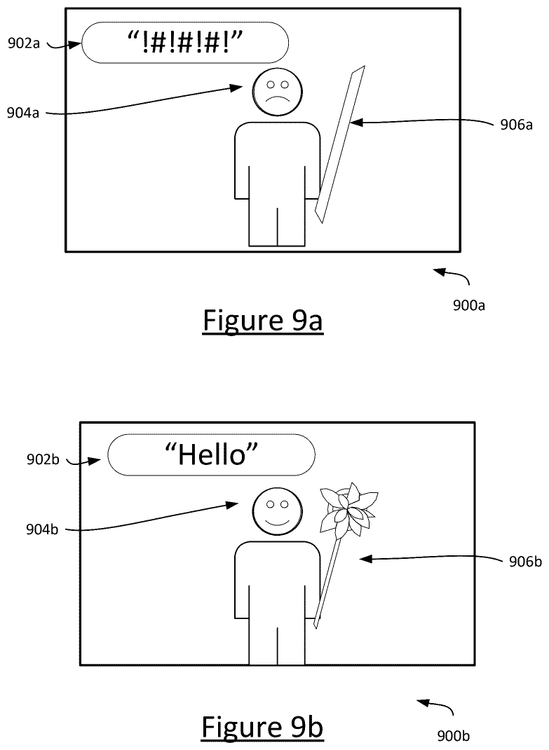

In another example, FIG. 9a illustrates an unmodified first video stream output 900a comprising a number of ‘age appropriate’ features appropriate for viewers above the age rating of the video game. Namely, the first video stream output 900a comprises expletive language 902a, a menacing character 904a and a weapon 906a. This content is not appropriate for the second user, who possesses the characteristic of being younger than the age rating of the video game.

The method 700 of FIG. 7 may comprise multiple iterations of the determining step 706 such that multiple rendering tasks may be determined as rendering tasks to be rendered differently. In this example, the determined rendering tasks comprise an audio rendering task with content comprising expletive language 902a, a first visual object rendering task with content comprising a menacing character 904a, and a second visual object rendering task with content comprising a weapon 906a.

In this example, it is desirable to generate a second rendering pipeline with an age rating suitable for the second user and subsequent users with this shared characteristic to the second user. Step 712b may comprise replacing the audio content of the audio rendering task with ‘clean’ language 902b; replacing the menacing character 904a of the first visual object rendering task with a friendly character 904b; and overlaying the weapon 906a of the second visual object rendering task with a non-violent object 906b, such as a flower.

In this way, a second modified video stream output 900b, as depicted in FIG. 9b, comprising the ‘clean’ language audio 902b, friendly character 904b and non-violent object 906b is generated, ensuring the video game content is appropriate for the age of the second user.

Whilst each embodiment of the invention has been described according to different characteristics, each example is merely an illustrative example to aid understanding of the invention. The examples given in relation to each embodiment are not intended to be limited or restricted to the embodiment with which they have been described. For example, the embodiment of FIG. 4 may produce the same video stream outputs as the illustrations in FIGS. 3, 8 and 9. Similarly, the embodiment of FIG. 2 may produce the same video stream outputs as the illustrations in FIGS. 5, 6, 8 and 9. It is understood that determining a first rendering task of the plurality of rendering tasks to be rendered differently may be dependent on one or more characteristics of a user not outlined in the examples described herein.

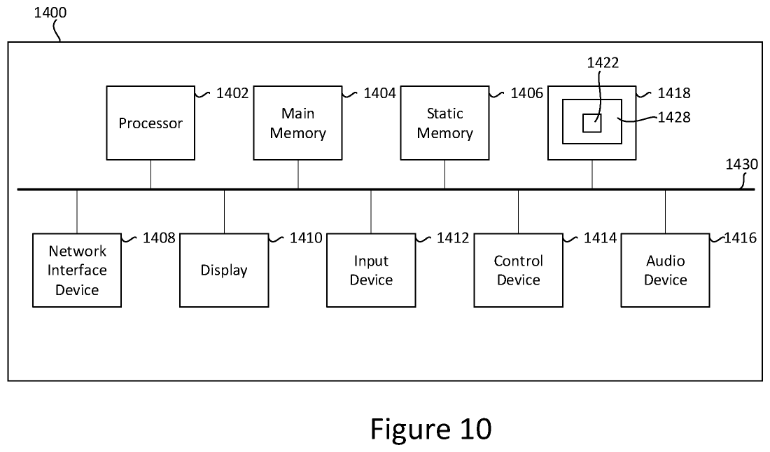

FIG. 10 illustrates a block diagram of one example implementation of a computing device 400 that can be used for implementing the method shown in FIGS. 1, 2, 4 and 7 and described throughout the detailed description. The computing device is associated with executable instructions for causing the computing device to perform any one or more of the methodologies discussed herein. In alternative implementations, the computing device 1400 may be connected (e.g., networked) to other machines in a Local Area Network (LAN), an intranet, an extranet, or the Internet. Optionally, a plurality of such computing devices may be used. The computing device may operate in the capacity of a server or a client machine in a client-server network environment, or as a peer machine in a peer-to-peer (or distributed) network environment. The computing device may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single computing device is illustrated, the term “computing device” shall also be taken to include any collection of machines (e.g., computers) that individually or jointly execute a set (or multiple sets) of instructions to perform any one or more of the methodologies discussed herein.

The example computing device 1400 includes a processing device 1402, a main memory 1404 (e.g., read-only memory (ROM), flash memory, dynamic random-access memory (DRAM) such as synchronous DRAM (SDRAM) or Rambus DRAM (RDRAM), etc.), a static memory 1404 (e.g., flash memory, static random-access memory (SRAM), etc.), and a secondary memory (e.g., a data storage device 1418), which communicate with each other via a bus 1430.

Processing device 1402 represents one or more general-purpose processors such as a microprocessor, central processing unit, or the like. More particularly, the processing device 1402 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 1402 may also be one or more special-purpose processing devices such as an application specific integrated circuit (ASIC), a field programmable gate array (FPGA), a digital signal processor (DSP), network processor, or the like. Processing device 1402 is configured to execute the processing logic (instructions 1422) for performing the operations and steps discussed herein.

The computing device 1400 may further include a network interface device 1408. The computing device 1400 also may include a video display unit 1410 (e.g., a liquid crystal display (LCD) or a cathode ray tube (CRT)), an alphanumeric input device 1412 (e.g., a keyboard or touchscreen), a cursor control device 1414 (e.g., a mouse or touchscreen), and an audio device 1414 (e.g., a speaker).

The data storage device 1418 may include one or more machine-readable storage media (or more specifically one or more non-transitory computer-readable storage media) 1428 on which is stored one or more sets of instructions 1422 embodying any one or more of the methodologies or functions described herein. The instructions 1422 may also reside, completely or at least partially, within the main memory 1404 and/or within the processing device 1402 during execution thereof by the computer system 1400, the main memory 1404 and the processing device 1402 also constituting computer-readable storage media.

The various methods described above may be implemented by a computer program. The computer program may include computer code arranged to instruct a computer to perform the functions of one or more of the various methods described above. The computer program and/or the code for performing such methods may be provided to an apparatus, such as a computer, on one or more computer readable media or, more generally, a computer program product. The computer readable media may be transitory or non-transitory. The one or more computer readable media could be, for example, an electronic, magnetic, optical, electromagnetic, infrared, or semiconductor system, or a propagation medium for data transmission, for example for downloading the code over the Internet. Alternatively, the one or more computer readable media could take the form of one or more physical computer readable media such as semiconductor or solid-state memory, magnetic tape, a removable computer diskette, a random-access memory (RAM), a read-only memory (ROM), a rigid magnetic disc, and an optical disk, such as a CD-ROM, CD-R/W or DVD.

In an implementation, the modules, components and other features described herein can be implemented as discrete components or integrated in the functionality of hardware components such as ASICS, FPGAs, DSPs or similar devices.

A “hardware component” is a tangible (e.g., non-transitory) physical component (e.g., a set of one or more processors) capable of performing certain operations and may be configured or arranged in a certain physical manner. A hardware component may include dedicated circuitry or logic that is permanently configured to perform certain operations. A hardware component may be or include a special-purpose processor, such as a field programmable gate array (FPGA) or an ASIC. A hardware component may also include programmable logic or circuitry that is temporarily configured by software to perform certain operations.

Accordingly, the phrase “hardware component” should be understood to encompass a tangible entity that may be physically constructed, permanently configured (e.g., hardwired), or temporarily configured (e.g., programmed) to operate in a certain manner or to perform certain operations described herein.

In addition, the modules and components can be implemented as firmware or functional circuitry within hardware devices. Further, the modules and components can be implemented in any combination of hardware devices and software components, or only in software (e.g., code stored or otherwise embodied in a machine-readable medium or in a transmission medium).

Unless specifically stated otherwise, as apparent from the following discussion, it is appreciated that throughout the description, discussions utilizing terms such as “providing”, “calculating”, “computing,” “identifying”, “detecting ”, “establishing”, “training”, “determining”, “storing”, “generating” , “checking”, “obtaining” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is to be understood that the above description is intended to be illustrative, and not restrictive. Many other implementations will be apparent to those of skill in the art upon reading and understanding the above description. Although the disclosure has been described with reference to specific example implementations, it will be recognised that the disclosure is not limited to the implementations described but can be practiced with modification and alteration within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

1. A computer-implemented method comprising;
generating a rendering pipeline comprising a plurality of rendering tasks;
determining a first rendering task of the plurality of rendering tasks that is to be rendered differently based at least in part on one or more characteristics of a user;
producing a first video stream output that is to be displayed to a first user that has a first characteristic; and
amending the first rendering task based at least on a characteristic of a second user that is different than the first characteristic of the first user; and
producing a second video stream output that is to be displayed to the second user.

2. The computer-implemented method of claim 1, wherein amending the first rendering task comprises, for the second user, bypassing the first rendering task to produce the second video stream output.

3. The computer-implemented method of claim 1, wherein amending the first rendering task comprises, for the second user, modifying a content of the first rendering task to produce the second video stream output.

4. The computer-implemented method of claim 3, wherein a rendered content of the first rendering task to be modified comprises text associated with the first user.

5. The computer-implemented method of claim 4, wherein modifying the content for display to the second user comprises replacing the text associated with the first user with a visual object or different text.

6. The computer-implemented method of claim 3, wherein the content of the first rendering task to be modified for display to the second user comprises a visual object, wherein modifying the content comprises blurring the visual object and/or overlaying the visual object with a predetermined modified visual object.

7. The computer-implemented method of claim 1, further comprising:
pausing rendering of the rendering pipeline when the first rendering task to be rendered differently is determined.

8. The computer-implemented method of claim 1, further comprising tagging the first rendering task.

9. The computer-implemented method of claim 8, further comprising:
generating a first rendering pipeline comprising a first version of the tagged rendering task; and
generating a second rendering pipeline comprising a second version of the tagged rendering task.

10. The computer-implemented method of claim 9, wherein the first version of the tagged rendering task is an unmodified version of the first rendering task.

11. The computer-implemented method of claim 9, wherein the first video stream output is associated with the first rendering pipeline and the second video stream output is associated with the second rendering pipeline.

12. The computer-implemented method of claim 11, wherein displaying the first modified video stream output on a first device and displaying the second modified video stream output on a second device occurs simultaneously.

13. The computer-implemented method of claim 11, wherein generating the second video stream output comprises:
modifying the first video stream output by replacing a first version of the tagged rendering task rendered in the first rendering pipeline with the rendered second version of the tagged rendering task rendered in the second rendering pipeline.

14. The computer-implemented method of claim 1, wherein the one or more characteristics of the user comprises one or more of the following: name; username; geographic location; language; age; relationship to the first user; and/or accessibility requirement.

15. The computer-implemented method of claim 1, wherein determining the first rendering task of the plurality of rendering tasks to be rendered differently is determined by machine learning.

16. One or more non-transitory computer-readable media that store instructions which, when executed by the one or more processors, cause the one or more processors to perform operations comprising:
generating a rendering pipeline comprising a plurality of rendering tasks;
determining a first rendering task of the plurality of rendering tasks that is to be rendered differently based at least in part on one or more characteristics of a user;
producing a first video stream output that is to be displayed to a first user that has a first characteristic; and
amending the first rendering task based at least on a characteristic of a second user that is different than the first characteristic of the first user; and
producing a second video stream output that is to be displayed to the second user.

17. A system comprising:
one or more processors, and
one or more non-transitory computer-readable media that store instructions which, when executed by the one or more processors, cause the one or more processors to perform operations comprising:
generating a rendering pipeline comprising a plurality of rendering tasks;
determining a first rendering task of the plurality of rendering tasks that is to be rendered differently based at least in part on one or more characteristics of a user;
producing a first video stream output that is to be displayed to a first user that has a first characteristic; and
amending the first rendering task based at least on a characteristic of a second user that is different than the first characteristic of the first user; and
producing a second video stream output that is to be displayed to the second user.

18. The system of claim 17, wherein amending the first rendering task comprises, for the second user, bypassing the first rendering task to produce the second video stream output.

19. The system of claim 17, wherein amending the first rendering task comprises, for the second user, modifying a content of the first rendering task to produce the second video stream output.

20. The system of claim 19, wherein a rendered content of the first rendering task to be modified comprises text associated with the first user.
